(19) United States
(12) Patent Application Publication
(10) Pub. No.: US 2004/0167028 A1
(43) Pub. Date: Aug. 26, 2004

(54) Method of introducing a substance into plant tissue

(75) Inventors: Atsunori Tsuji, Hamamatsu-shi (JP); Hiroshi Uchida, Hamamatsu-shi (JP); Takaji Yamashita, Hamamatsu-shi (JP); Shinpei Matsuhashi, Takasaki-shi (JP); Satoshi Watanabe, Takasaki-shi (JP); Noriko S. Ishioka, Takasaki-shi (JP)

Correspondence Address: MORGAN LEWIS & BOCKIUS LLP, 1111 PENNSYLVANIA AVENUE NW, WASHINGTON, DC, 20004, US

(73) Assignee: HAMAMATSU PHOTONICS K.K.

(21) Appl. No.: 10/719,062

(22) Filed: Nov. 24, 2003

(30) Foreign Application Priority Data
Nov. 25, 2002 (JP) P2002-341498

(51) Int. Cl. A01N 25/00

(52) U.S. Cl. 504/116.1

(57) ABSTRACT

A method of introducing a substance into plant tissue whereby the substance is introduced into the tissue of a plant having branches through the branch, wherein the substance is absorbed through conductive tissue of the branch while inhibiting means is carried out in order to inhibit transpiration through a leaf on the branch or to inhibit water requirement by the leaf.

### BACKGROUND OF THE INVENTION

1. Field of the Invention

The present invention relates to a method of introducing substances into plant tissue.

2. Related Background of the Invention

For plant cultivation, plants must be supplied with various substances such as nutrients, plant hormones and chemicals, depending on the growth period and nutritional condition, in order to promote growth of the plant and to protect the plant from insects, disease and the like. Such substances have traditionally been dispersed on the soil or sprayed on the leaves of plants for growth regulation, pest control, etc.

FIG. 18 is a schematic view showing conduction of a substance through conductive tissue of a plant after soil dispersion of the substance. The plant 10 shown in this drawing comprises roots 5 in the soil, a main stem 3 extending above the soil from the roots 5 and leaves 1 and fruit 7 produced from the main stem 3. Sieve tubes 8 and vessels 9 are present in the plant 10 as the conductive tissue for transport of water and nutrients to each tissue. The plant 10 absorbs the soil-dispersed substance together with water and nutrients through its roots 5 in the soil, and transports it to the leaves 1 and fruit 7 through the vessels 9 serving as part of the conductive tissue in the stem 3 above the soil.

FIG. 19 is a schematic view showing leaf spraying of a substance onto a plant. The leaf spraying shown in this drawing is carried out using spraying means 30 to spray the substance onto the leaves 1 of the plant 10. Plants also absorb water and nutrients through their leaves, and the organic substances produced by photosynthesis as well as absorbed water and nutrients are transported through sieve tubes to the roots and other plant tissue. Leaf dispersion takes advantage of this function whereby plants absorb water and nutrients through their leaves as well as through their roots.

One method for introducing a substance into plant tissue by means other than the original mechanisms of the plant as described above, is the microbial introduction method disclosed in Japanese Patent Application Laid-Open No. 9-278620, wherein a tool such as an injection needle, bud scratcher, leaf scratcher or the like is used to forcefully introduce a specific microbe into the plant tissue.

### SUMMARY OF THE INVENTION

In the aforementioned prior art method, however, selectivity of substance absorption into the tissue by the surface cells of the plant limits the types of substances that can be introduced, reduces the amounts of substances that can be introduced and slows the rate of introduction. Particularly in the case of leaf spraying, the sprayed substances attach onto the leaves and block light from reaching them, thereby reducing the amount of light absorbed by the leaves. When substances are sprayed onto portions other than the leaves (such as fruit), there is a risk of chemical injury at those portions. In addition, the sprayed substances tend to persist in the environment, including the plant surface and soil, and in some cases introduction of the substances continues even after the desired period of introduction.

It is an object of the present invention, which has been accomplished in, light of the problems mentioned above, to provide a method of introducing substances into plant tissue which does not limit the types of substances that can be introduced into the plant tissue, which allows a greater amount of substances to be introduced, and which allows the substance introduction period to be controlled.

The present inventors have observed migration of substances in plant tissue using a positron emission nuclear species, and have discovered that large amounts of substances can be rapidly introduced into plant tissue by removing all of the leaves which extend from a side branch and introducing the substances through the removed sections, instead of by the conventional method of introducing the substances into plant tissue from the tips of cut leaves.

The method of introducing substances into plant tissue according to the invention is based on this discovery, whereby there is provided a method of introducing a substance into plant tissue whereby the substance is introduced into the tissue of a plant having branches through the branch, wherein the substance is absorbed through conductive tissue of the branch while inhibiting means is carried out in order to inhibit transpiration through a leaf on the branch or to inhibit water requirement by the leaf. The above-mentioned branch includes side branch (lateral branch).

As inhibiting means there may be mentioned (1) removal of at least one of the leaves, (2) shading of at least one of the leaves and (3) closure of stomata of the leaves, where the means of (3) may be accomplished by introducing into the tissue of the leaves a chemical which closes the stomata.

According to the method of the invention, the conductive tissue is preferably exposed by removal of the tissue of the branch, the substance is preferably introduced through the exposed conductive tissue and the conductive tissue preferably consists of vessels. By removing the branch tissue to expose the conductive tissue, it is possible to achieve direct contact between the conductive tissue cells and the substance, thereby allowing more reliable introduction of a greater amount of the substance.

In the method of the invention as described above, the substance is preferably at least one substance selected from the group consisting of nutrients, plant hormones, chemicals, nucleic acids and useful microbes, and the plant is preferably a dicotyledonous plant.

### BRIEF DESCRIPTION OF THE DRAWINGS

FIG. 1 is a schematic view of a plant into which a substance has been introduced through the conductive tissue of a branch after removal of leaves on the branch.

FIG. 2 is a magnified view of the portion indicated as “A” in FIG. 1.

FIG. 3 is a schematic view showing a plant into which a substance has been introduced through the conductive tissue of a branch while shading the leaves on the branch.

FIG. 4 is a schematic view showing a plant into which a substance has been introduced through the conductive tissue of a branch while applying a chemical which closes the stomata of the leaves on the branch.

FIG. 5 is a view showing the basic construction of a positron imaging apparatus.

FIG. 6 is a schematic view showing the arrangement of the main stem 3 and side branches 2 of the tomato plant used in Example 1 and Comparative Example 1.

FIG. 7 is an integrated image for Comparative Example 1 obtained from a positron imaging apparatus.

FIG. 8 is an integrated image for Example 1 obtained from a positron imaging apparatus.

FIG. 9 is a graph showing the periodic change in nitric acid absorption at the nodes for Comparative Example 1 and Example 1.

FIG. 10 is a schematic view showing the arrangement of the main stem 3 and side branches 2 of the tomato plant used in Example 2 and Comparative Example 2.

FIG. 11 is an integrated image for Example 2 obtained from a positron imaging apparatus.

FIG. 12 is an integrated image for Comparative Example 2 obtained from a positron imaging apparatus.

FIG. 13 is a graph showing the periodic change in nitric acid absorption: at the nodes for Comparative Example 2 and Example 2.

FIG. 14 is a schematic view showing the arrangement of the main stem 3 and side branches 2 of the tomato plant used in Examples 3 and 4.

FIG. 15 is an integrated image for Example 3 obtained from a positron imaging apparatus.

FIG. 16 is an integrated image for Example 4 obtained from a positron imaging apparatus.

FIG. 17 is a graph showing the periodic change in nitric acid absorption at the nodes for Examples 3 and 4.

FIG. 18 is a schematic view showing conduction of a substance through conductive tissue.

FIG. 19 is a schematic view showing leaf spraying of a substance onto a plant.

### DESCRIPTION OF THE PREFERRED EMBODIMENTS

A preferred mode of the method of introducing substances into a plant according to the invention will now be explained in detail with reference to the accompanying drawings. Identical elements are indicated by the same reference numerals and will be explained only once.

The present invention may be employed for any type of plant, but dicotyledonous plants are preferred, with greenhouse cultivated crops or fruit crops being more preferred. As dicotyledonous plants there may be mentioned herbaceous and arboreal dicotyledonous plants.

As greenhouse cultivated crops there may be mentioned solanaceous crops such as eggplant, tomato and the like; cucurbitaceous crops such as cucumber, melon, pumpkin and the like; vitaceous crops such as grapes and the like; rosaceous crops such as peach, apple, pear, loquat, peach, plum, cherry, and the like; leguminous crops, lamiaceous crops, gentianaceous crops, asteraceous crops, umbelliferous crops and actinidiaceous crops. As fruit crops there may be mentioned vitaceous and rosaceous deciduous fruits, as well as citrus fruits such as lime, lemon, tangerine, orange, kabosu lime, kumquat, trifoliate orange and the like.

Crops with high requirements for nutrients such as boron, calcium and magnesium (for example, tomatoes) must be supplied with substances essential for growth especially during the period of intense growth from planting to fructification. Factors including the amount and timing, of introduction of the substances have a major effect on harvest size, quality and quantity. The method of the present invention is therefore highly effective for such crops.

The substance introduced into the plant is preferably at least one substance selected from the group consisting of nutrients, plant hormones, chemicals, nucleic acids and useful microbes.

As nutrients there may be mentioned nitrogenous compounds (nitric acid, ammonia, glutamic acid, aspartic acid, amide nitrogen, ureide nitrogen, etc.), sugars (sucrose, glucose, starch, etc.), amino acids (glycine, alanine, valine, leucine, isoleucine, proline, serine, cysteine, methionine, asparagine, glutamine, histidine, tryptophan, etc.), vitamins (vitamin B₆ hydrochloride, vitamin B₁ hydrochloride, etc.), antibiotics, and other essential elements or compounds containing them (phosphorus, potassium, calcium, magnesium, sulfur, iron, manganese, copper, zinc, molybdenum, boron, chlorine, silicon, sodium, cobalt, nickel, aluminum, selenium, nicotinic acid, inositol, etc.).

As plant hormones there may be mentioned auxins, cytokinins, gibberellins, ethylene, abscisic acid, brassinosteroids and jasmonic acid. As chemicals there may be mentioned epidemic controllers, antiviral agents, microbicides, attractants and repellents, and plant growth regulators (ethylene agents, auxin agents, cytokinin agents, gibberellin agents, auxin antagonists, gibberellin biosynthesis inhibitors, etc.). As nucleic acids there may be mentioned RNA, DNA, etc. As useful microbes there may be mentioned soil disease protecting microbes (Pseudomonas bacteria), or microbes belonging to the genus Fusarium, Actinomadura, Streptomyces, Enterobacter, Acinetobacter, Bacillus, Paecilomyces, Erbinia, Serratia and Trichoderma.

The aforementioned substances are introduced into plant tissue through the conductive tissue of the side branches of plants. Here, “into plant tissue” means into the body of the plant (for example, into the epidermal system, into the fundamental tissue or into the vascular bundle system). Conductive tissue refers to tissue which conducts, water and nutrients within plant tissue, and includes vessels and sieve tubes.

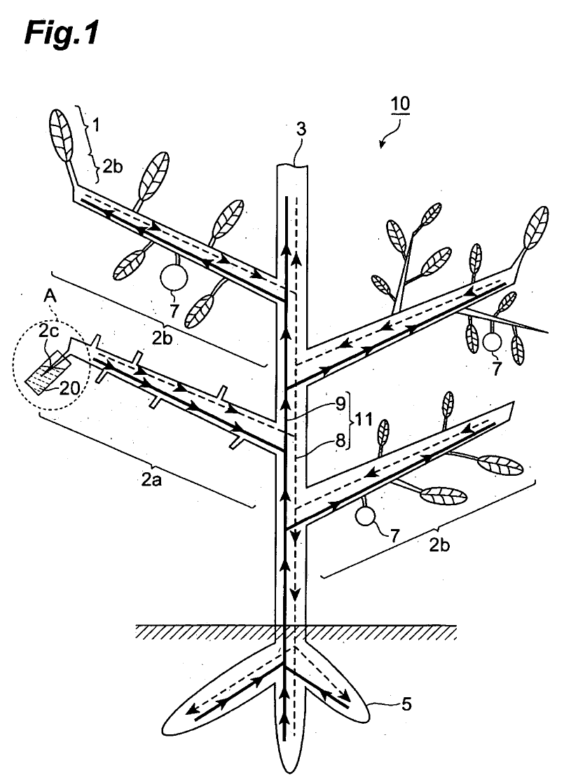

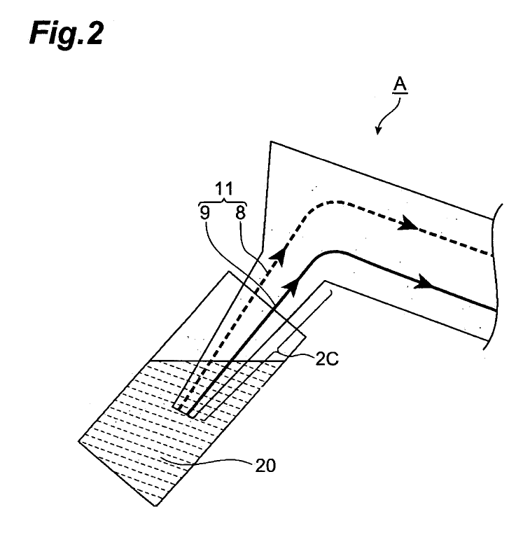

As means for inhibiting transpiration, there may be mentioned removal of at least one leaf on a branch. FIG. 1 is a schematic view of a plant into which a substance has been introduced through the conductive tissue of a branch after removal of leaves on the branch. FIG. 2 is a magnified view of the portion indicated as “A” in FIG. 1. The plant 10 in FIG. 1 comprises roots 5 in the soil, a main stem 3 extending above the soil from the roots 5, side branches 2a,2b branching from the main stem 3, and leaves 1 and fruits 7 produced on the side branches 2a,2b. The, plant 10 contains conductive tissue 11 consisting of sieve tubes 8 and vessels 9, which have the function of transporting water and nutrients to each tissue. The side branch 2a is a side branch to which transpiration-inhibiting means is applied, while the side branch 2b is a side branch wherein the inhibiting means is not applied. The side branch 2c is a side branch which branches from the side branch 2a.

In FIGS. 1 and 2, all of the leaves 1 on the side branch 2a have been removed, and the side branch 2c contacts with the substance 20. As shown in greater detail in FIG. 2, the conductive tissue 11 in the side branch 2c (consisting of sieve tubes 8 and vessels 9) is exposed at the end of the side branch 2c. The side branch 2c is inserted into the substance 20 so that the exposed conductive tissue 11 and substance 20 come into contact.

In the plant 10 shown in FIGS. 1 and 2, removal of the leaves 1 restricts substance migration through the original vessels 9 of the side branch 2a of the plant in the direction from the main stem 3 to the side branch 2a, such that the driving force of transpiration from the leaves 1 on the side branch 2b produces a flow of substances from the side branch 2a to the main stem 3 (the solid arrow lines in FIGS. 1 and 2). The flow results in absorption of the substance 20 through the exposed vessels 9. Since substance migration in the sieve tubes 8 is already from the side branch 2a toward the main stem 3, the sieve tubes 8 also conduct migration of the substance 20 from the side branch 2a to the main stem 3. By applying the method of the invention, therefore, it is possible to more reliably incorporate the substance 20 into the tissue of the plant 10 in a high introduction volume.

Furthermore, since the substance 20 is directly introduced into the conductive tissue 11 and not through the cell membrane as is the case with absorption through the roots or leaves, there are no restrictions on the substances that may be introduced. Moreover, this method does not result in residue of the substance 20 in the soil, and the period for introduction of the substance can be controlled by varying the contact time between the side branch 2c and substance 20 or by varying the direction of flow of the vessels. The site of introduction may be selected as desired, and the substance may be rapidly introduced while varying the introduction volume at the site at which the substance is to be introduced. Light absorption is also increased because the leaves 1 are not covered with the substance 20.

The above-mentioned inhibiting means is easy to handle and transpiration can be reliably inhibited since the transpiration mediating stomata are removed with removal of the leaves. When this type of inhibiting means is employed, all or only some of the leaves of the side branches may be removed. The leaves may be removed either by hand or using a trimming or cutting tool.

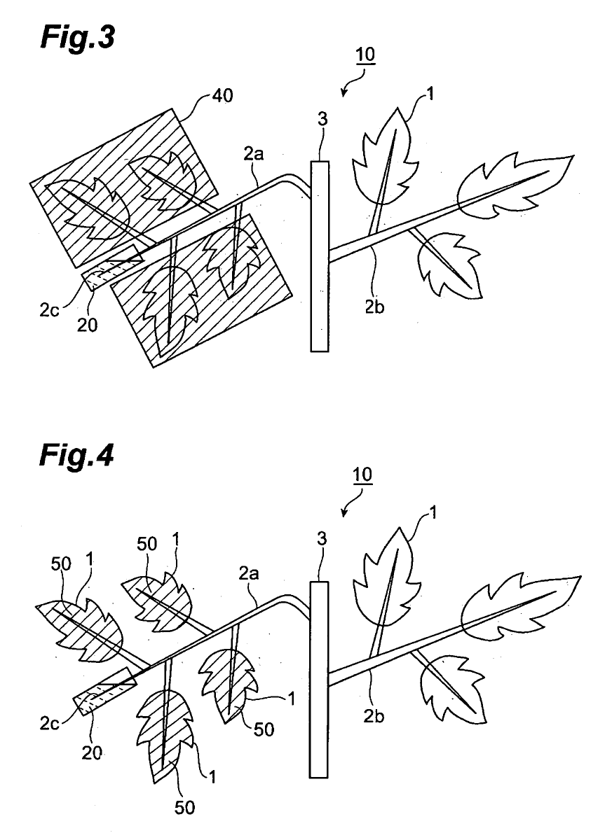

As another transpiration inhibiting means there may be mentioned shading of at least one leaf on a side branch. FIG. 3 is a schematic view showing a plant into which a substance has been introduced through the conductive tissue of a branch while shading the leaves on the branch. The plant 10 shown in this drawing comprises a main stem 3, side branches 2a,2b branching from the main stem 3, and leaves 1 produced on the side branches 2a, 2b. The leaves 1 on the side branch 2a are shaded with a shading material 40, and a side branch 2c created by removal of a leaf contacts with the substance 20.

This shading of the leaves inhibits photosynthesis carried out by the leaves, thereby reducing the water requirement of the leaves, while closure of the stomata inhibits transpiration of water by the stomata. The result is inhibition of the original substance migration in the plant from the main stem 3 toward the side branch 2a, such that the driving force of transpiration from the leaves 1 on the side branch 2b creates suction force on the main stem 3 and produces a flow of substances from the side branch 2a to the main stem 3. The flow results in absorption of the substance 20 through the conductive tissue of the side branch 2c. By applying the method of the invention, therefore, it is possible to more reliably incorporate the substance 20 into the tissue of the plant 10 in a high introduction volume.

Moreover, the aforementioned method allows the direction of flow in the vessels and transpiration to be controlled without destroying the plant tissue. It is thus possible to accomplish continuous introduction of a substance for prolonged periods through a site which has previously absorbed the substance (side branch 2c), to satisfactorily maintain the condition of the plant.

As shading materials 40 there may be used agricultural base fabrics, such as butter muslin, or polynets, woven fabrics, nonwoven fabrics, aluminum foil, black polyethylene sheets, black vinyl sheets and the like. The shading material 40 may be wrapped, around or attached to the leaves to cover and block the light from them.

As another transpiration inhibiting means there may be mentioned closure of stomata of the leaves on the branch using a chemical. FIG. 4 is a schematic view showing a plant into which a substance has been introduced through the conductive tissue of a branch while applying a chemical which closes the stomata, of the leaves on the branch. The plant 10 shown in this drawing comprises a main stem 3, side branches 2a,2b branching from the main stem 3, and leaves 1 produced on the side branches 2a,2b. The leaves 1 on the side branch 2a are coated with a chemical which closes the stomata, and a side branch 2c created by removal of a leaf 1 contacts with the substance 20. The chemical 50 used here is a plant hormone such as abscisic acid.

This closure of the stomata inhibits transpiration of water from the stomata. As a result, the driving force of suction by the main stem 3 due to transpiration from the leaves 1,on the side branch 2b produces, a flow of substances from the side branch 2a toward the main stem 3, in the same manner explained above. The flow also results in absorption of the substance 20 through the conductive tissue of the side branch 2c, thereby allowing the substance 20 to be reliably incorporated into the tissue of the plant 10 in a high introduction volume.

In the method of introducing substances into plant tissue according to the invention, the conductive tissue is preferably exposed by removing tissue of a side branch and the substance is introduced through the exposed conductive tissue. The conductive tissue is, preferably vessels.

The conductive tissue may be exposed by a method of removing the leaves, a method of cutting off a portion of the side branch using a trimming or cutting tool, or a method of shaving off a portion of the side branch with a similar tool. Such tissue removal is preferably accomplished on a leaf at the end of the side branch. Also, whole or some portion of the leaf may be removed. The leaves are preferably removed in the water.

It is believed that absorption of the substance occurs through the vessels and sieve tubes, with most of the absorption occurring through the vessels. However, special transfer cells are also present between the sieve tubes and vessels for lateral migration from the xylem. Substances absorbed through the vessels often migrate into the sieve tubes via the transfer cells and are incorporated into the plant tissue through the sieve tubes.

The absorbed substance may be either a solid or liquid substance at ordinary temperature. A solid substance is preferably dissolved or dispersed in a solvent in order to be in a liquid form at least at the time of absorption. When the substance is a liquid, it may be used as a formulation, such as an emulsion, solution, oil or the like. There may also be used aerosol, coating agent, ointment and sol forms. A woven fabric or nonwoven fabric may also be soaked with the substance and contacted with the conductive tissue.

According to the method of the invention, information relating to the amount, speed and site of introduction of the substance introduced into the plant tissue can be obtained, for example, using a positron imaging apparatus. With a positron imaging apparatus, information on the measuring target is obtained by introducing a substance labeled with positron-emitting RI as a tracer into a living body, and measuring the pair of gamma-rays produced as the positrons emitted from the RI-labeled substance are annihilated against electrons in the substance (see, for example, Japanese Patent Application Laid-Open No. 9-33658).

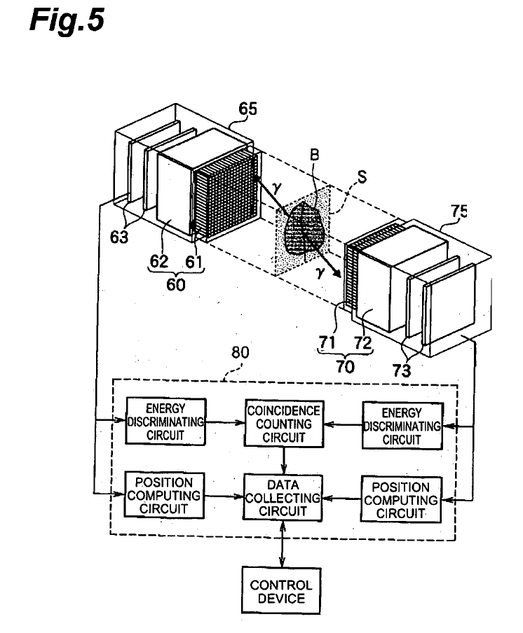

FIG. 5 is a view showing the basic construction of a positron imaging apparatus. The apparatus shown in this drawing comprises a pair of two-dimensional radiation detectors 60 and 70. The two-dimensional radiation detectors 60 and 70 in turn comprise scintillator arrays 61,71 each composed of a plurality of scintillators, and photodetectors 62,72 for detection of scintillation light generated by incidence of the gamma-rays on the scintillator arrays 61,71. The radiation detectors 60,70 are housed in separate detector cases 65,75 with the radiation incidence planes of the scintillator arrays 61,71 facing each other.

In this construction, a pair of gamma-rays emitted from a measuring target B (a plant, according to the invention) placed on a prescribed measuring surface S between the radiation detectors 60,70 are each detected by the radiation detectors 60,70. The detection signals are outputted through connected circuit systems 63,73 having amplifier circuits, etc. for amplification of the detection signals. The outputted amplification signals are inputted into a signal processing circuit 80, and the signal processing circuit 80 identifies coincident electron/positron annihilation events and calculates the position of the annihilation, based on the detection signals from the two radiation detectors 60,70.

### EXAMPLES

The present invention will now be explained in greater detail, with the understanding that the invention is in no way limited thereby.

### Substance Introduction by Leaf Removal

### Comparative Example 1

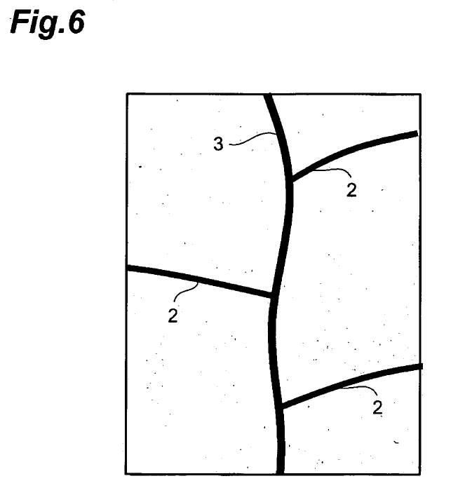

Tomato (Merryroad variety) approximately 4 weeks after sprouting was used as the test plant. After removing a leaf at the end of the 6th side branch from the bottom of the main stem, the end was cut in the water for use as the absorption site (conductive tissue-exposed side branch) FIG. 6 is a schematic view showing the arrangement of the main stem 3 and side branches 2 of the tomato plant used in this experiment. The absorption site was located at the end of the side branch 2 extending toward the left in FIG. 6.

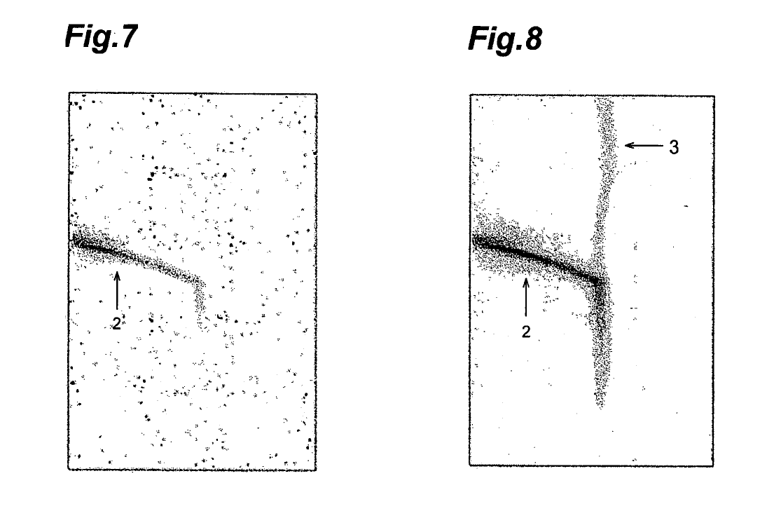

First, an aqueous solution containing ¹³N-labeled nitric acid was absorbed through the absorption site, and the movement and amount of introduction of the nitric acid in the side branch and main stem was observed for 1 hour using a positron imaging apparatus (IPS-1000, Hamamatsu Photonics, KK.) having the same basic construction as shown in FIG. 5. FIG. 7 is an integrated image obtained from the positron imaging apparatus, with the integrated image positioned to correspond to the positions of the main stem and side branch in FIG. 6.

### Example 1

Next, all of the leaves on the substance-absorbed side branch 2 of the tomato plant used in Comparative Example 1 were removed. In order to observe the transpiration-inhibiting effect produced by removal of the leaves, an aqueous solution containing, ¹³N-labeled nitric acid was absorbed in the same manner as Comparative Example 1, and an integrated image was also obtained in the same manner as Comparative Example 1. FIG. 8 is the integrated image obtained from the positron imaging apparatus, with the integrated image positioned to correspond to the positions of the, main stem and side branch in FIG. 6.

As shown in the integrated images of FIGS. 7 and 8, in the side branch of Comparative Example 1 having leaves and thus without inhibition of transpiration, flow of the substance in the vessels was in the direction from the main stem toward the side branch. Thus, almost all of the substance was introduced into the sieve tubes, this being reflected by the fact that almost all of the substance migrated downward in the main stem. On the other hand, in the side branch of Example 1 from which the leaves had been removed, the flow of the substance in the vessels was in the direction from the side branch toward the main stem. The substance was therefore introduced not only into the sieve tubes but also the vessels. Upward migration was also confirmed in the main stem, following the flow induced by the driving force of transpiration by the other side branches. The integrated images of FIGS. 7 and 8 also confirmed that the amount of substance introduced into the plant was greater in Example 1 in which transpiration was inhibited, and that the amount of substance introduced was smaller through the sieve tubes alone.

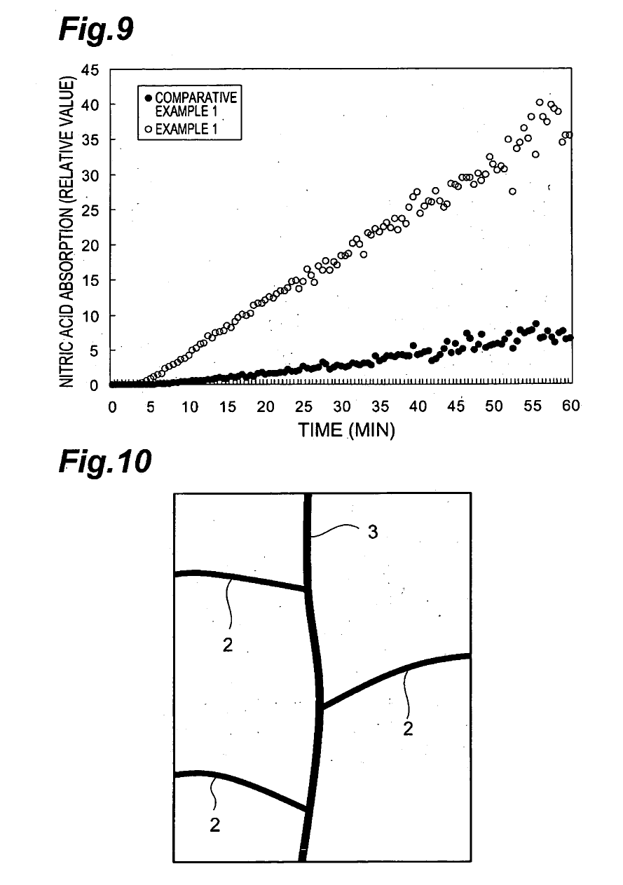

FIG. 9 is a graph showing the periodic change in RI accumulation (nitric acid absorption) at the nodes, i.e. the branch points between the side branches with absorption sites and the main stem. These results also confirmed over twice the amount of substance introduction by the side branch in Example 1 having the leaves removed to inhibit transpiration. Thus, it was confirmed that the introduction volume was greater when introduction was also through the vessels instead of through the sieve tubes alone, and that a greater volume of introduction occurred through the vessels than through the sieve tubes.

### Substance Introduction by Leaf Shading

### Example 2

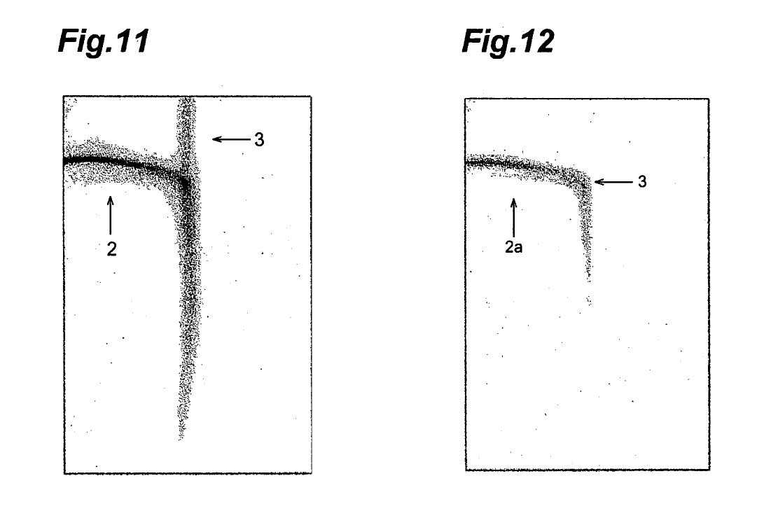

Using a different tomato plant from that used in Example 1 (the same variety but a different plant), a leaf at the end of the 6th side branch from the bottom of the main stem was removed in the same manner as Example 1, and the end was cut in the water for use as the absorption site in the same manner as Comparative Example 1. The other leaves on that side branch were shaded by covering them with aluminum foil to inhibit transpiration. FIG. 10 is a schematic view showing the arrangement of the main stem 3 and side branches 2 of the tomato plant used in this experiment. The absorption site was located at the end of the upper side branch 2 of the side branches 2 extending toward the left in FIG. 10. In order to observe the transpiration-inhibiting effect produced by shading of the leaves, an aqueous solution containing ¹³N-labeled nitric acid was absorbed through the absorption site, and an integrated image was obtained in the same manner as Example 1. FIG. 11 is the integrated image obtained from the positron imaging apparatus, with the integrated image positioned to correspond to the positions of the main stem and side branch in FIG. 10.

### Comparative Example 2

Using the same tomato plant of Example 2, the covering was removed from the leaves of the side branch which had absorbed the substance. An aqueous solution containing ¹³N-labeled nitric acid was absorbed in the same manner as Example 2 in order to observe introduction of the substance under conditions without leaf shading, and an integrated image was also obtained in the same manner as Example 2. FIG. 12 is the integrated image obtained from the positron imaging apparatus, with the integrated image positioned to correspond to the positions of the main stem and side branch in FIG. 10.

As shown in the integrated images of FIGS. 11 and 12, and particularly as confirmed by FIG. 12, very little of the substance had been introduced,into the side branch of Comparative Example 2 which had the leaves of the side branch unshaded and thus had no inhibition of transpiration. On the other hand, in the side branch of Example 2 which had the leaves shaded to inhibit transpiration, flow of the substance in the vessels of the side branch 2 was in the direction from the leaves toward the main stem so that the substance was introduced also into the vessels, while upward migration occurred in the main stem following the flow due to the driving force of transpiration by the other side branches, as confirmed by FIG. 11. The integrated images of FIGS. 11 and 12 also confirmed that the amount of substance introduced into the plant was greater in the side branch of Example 2 in which transpiration was inhibited, and that the amount of substance introduced was smaller through the sieve tubes alone.

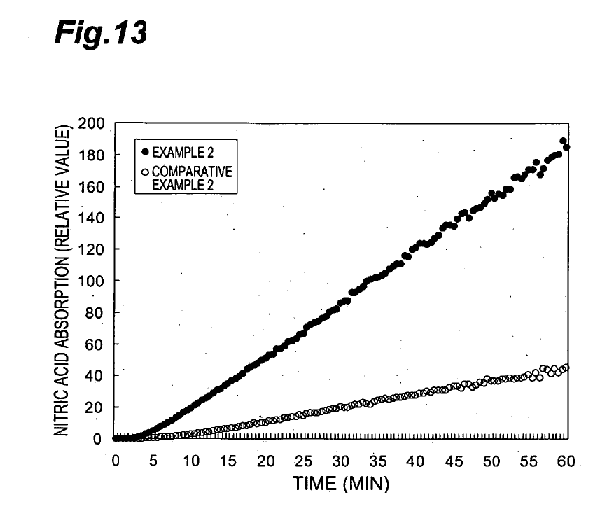

FIG. 13 is a graph showing the periodic change in RI accumulation at the nodes, i.e. the branch points between the side branches with absorption sites and the main stem. These results also confirmed over twice the amount of substance introduction by the side branch in Example 2. having the leaves shaded to inhibit transpiration. In other words, it was confirmed that the introduction volume was greater when it was also through the vessels instead of through the sieve tubes alone, and that a greater volume of introduction occurred through the vessels than through the sieve tubes.

### Substance Introduction Through Vessels Alone by Heat Treatment

### Example 3

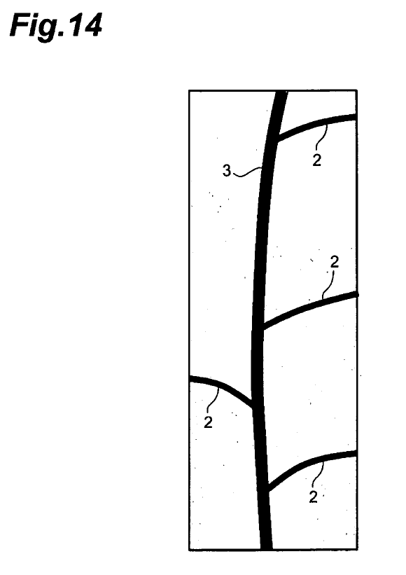

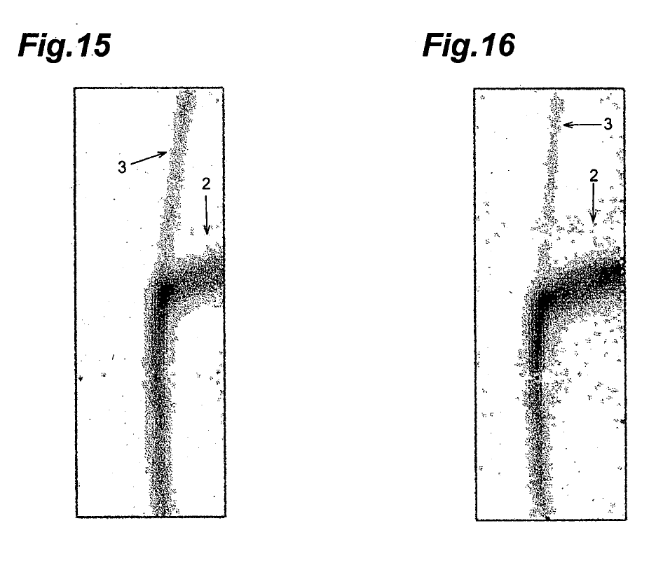

Using a different tomato plant from that used in Example 1 (the same variety but a different plant), a leaf at the end of the 8th side branch from the bottom of the main stem was removed in the same manner as Example 1, and the end was cut in the water for use as the absorption site in the same manner as Example 1. The other leaves on that side branch were removed in the same manner as Example 1. FIG. 14 is a schematic view showing the arrangement of the main stem 3 and side branches 2 of the tomato plant used, in this experiment. The absorption site was located at the end of the middle side branch 2 of the side branches 2 extending toward the right in FIG. 14. An aqueous solution containing ¹³N-labeled nitric acid was absorbed in the same manner as Example 1, and an integrated image was also obtained in the same manner as Example 1. FIG. 15 is the integrated image obtained from the positron imaging apparatus, with the integrated image positioned to correspond to the positions of the, main stem and side branch in FIG. 14.

### Example 4

In order to eliminate the transporting function of the sieve tubes in the side branch 2 and render active only the transporting function of the vessel paths, using the same tomato plant as in Example 3, a part of the side branch which had absorbed the substance was heated at about 100° C. in a ring fashion.

The heating eliminated the transporting function of the sieve tubes to render active only the transporting function of the vessels. In order to observe the effect resulting from the transporting function of the vessels alone, an aqueous solution containing ¹³N-labeled nitric acid was absorbed in the same manner as Example 3, and an integrated image was also obtained in the same manner as Example 3. FIG. 16 is the integrated image obtained from the positron imaging apparatus, with the integrated image positioned to correspond to the positions of the main stem and side branch in FIG. 14.

Based on the integrated images of FIGS. 15 and 16, since the integrated image of the sieve tube-eliminated side branch obtained in Example 4, indicated that the substance had been introduced into the plant, it was confirmed that introduction of the substance into the plant was achieved through the vessels.

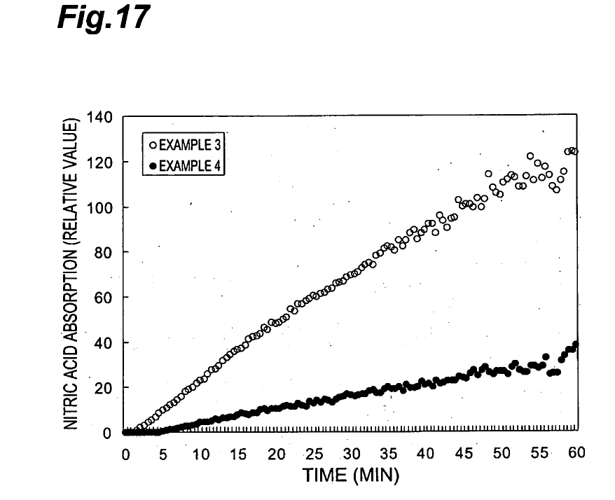

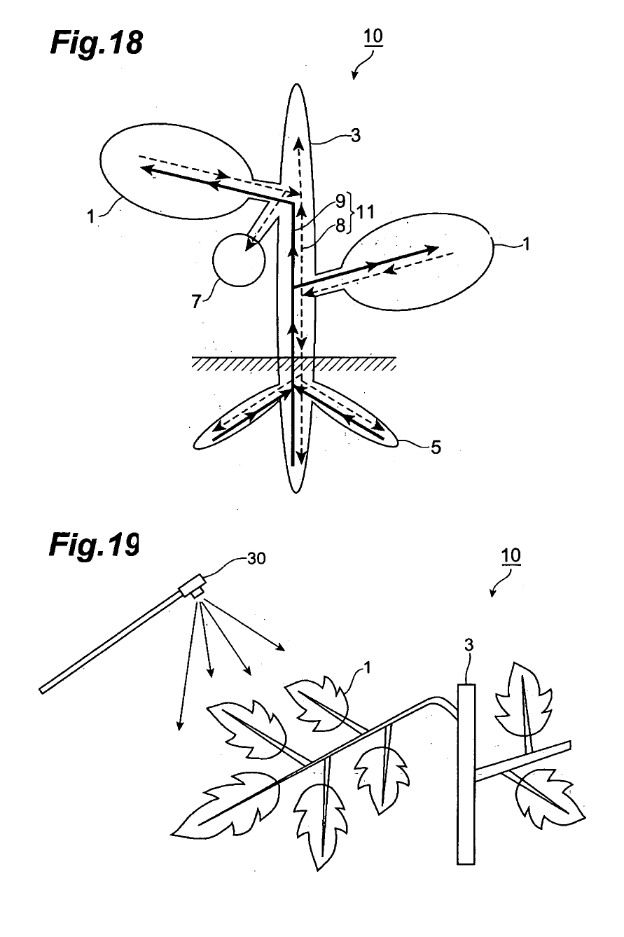

FIG. 17 is a graph showing the periodic change in RI accumulation at the nodes i.e. the branch points between the side branches with absorption sites and the main stem. These results indicate a greater volume of introduction through the sieve tubes than, through the vessels, in contrast to FIG. 9 and FIG. 13, but it is believed that this occurred because the sieve function-eliminating treatment also affected flow through the vessels.

As demonstrated above, the method of introducing substances into plants according to the present invention can be carried out without limitation on the types of substances that can be introduced, allows relatively large amounts of substances to be introduced into plant tissue, and allows the substance introduction period to be controlled. Moreover, the site of introduction may be selected as desired, and the substance may be rapidly introduced while varying the introduction volume at the site at which the substance is to be introduced. In addition, since the substance is not attached to the leaves other than those on the side branch having the absorption site, unlike in the case of leaf spraying, it is possible to maintain a sufficient level of light absorption, and since the substance does not remain in the soil, the method is environment-friendly and allows introduction of relatively large amounts of substances in short periods of time. The method of the invention is particularly effective for plants such as tomatoes, which require introduction of relatively large amounts of substances during necessary periods.

What is claimed is:

1. A method of introducing a substance into plant tissue whereby the substance is introduced into the tissue of a plant having branches through the branch,
wherein the substance is absorbed through conductive tissue of the branch while inhibiting means is carried out in order to inhibit transpiration through a leaf on the branch or to inhibit water requirement by the leaf.

2. The method of claim 1, wherein the inhibiting means is removal of at least one of the leaves.

3. The method of claim 1, wherein the inhibiting means is shading of at least one of the leaves.

4. The method of claim 1, wherein the inhibiting means is closure of stomata of the leaves.

5. The method of claim 4, wherein the closure is accomplished by introducing into the tissue of the leaves, a chemical which closes the stomata.

6. The method of claim 1, wherein the conductive tissue is exposed by removal of the tissue of the branch, and the substance is introduced through the exposed conductive tissue.

7. The method of claim 1, wherein the conductive tissue consists of vessels.

8. The method of claim 1, wherein the substance is at least one substance selected from the group consisting of nutrients, plant hormones, chemicals, nucleic acids and useful microbes.

9. The method of claim 1, wherein the plant is a dicotyledonous plant.
